(19) United States
(12) Patent Application Publication
(10) Pub. No.: US 2012/0074916 A1
(43) Pub. Date: Mar. 29, 2012

(54) Switch-Mode Voltage Regulator

(75) Inventor: Séverin Trochut, Gily Sur Isere (FR)

(73) Assignee: ST-ERICSSON SA, Plan-les-Ouates (CH)

(21) Appl. No.: 13/130,223

(22) PCT Filed: Nov. 20, 2009
(86) PCT No.: PCT/EP2009/065575

§ 371 Date: Jul. 29, 2011

(30) Foreign Application Priority Data
Nov. 25, 2008 (EP) 08305834.7

(51) Int. Cl. G05F 1/46

(52) U.S. Cl. 323/271

(57) ABSTRACT

The invention concerns a switch-mode voltage regulator, comprising : an inductor (L); a generator for producing a voltage ramp (16); circuitry (12, 13) for producing at least one pulse stream from said voltage ramp; switch control circuitry (14) for controlling switching of a current in the inductor according to said pulse stream; and a first control loop adapted to modulate the form of the voltage ramp according to the current flowing in the inductor.

### FIELD OF THE INVENTION

The present invention concerns switch-mode power supplies (DC-DC converters), in particular those in integrated circuit form capable of providing a regulated output power supply both below and above the unregulated input power supply. Such DC-DC converters are commonly known as buck-boost converters or step UP/DOWN DC/DC converters.

### BACKGROUND OF THE INVENTION

Switched mode power supplies are widely used in battery powered equipment to convert an unregulated supply from the battery voltage into a regulated supply for other electronic circuits which are highly sensitive to power supply stability.

The voltage supplied by batteries varies significantly as a function of the level of charge remaining. Therefore, the wider the range of voltage the electronic circuits can function over, the longer the equipment can be used between changing or charging the battery. For example, it is common for the voltage supplied by the battery in a mobile battery powered equipment to be allowed to drop from about 5V just after charging down to below 3V before the user is prompted to recharge the battery.

However some electronic circuits only function at voltage above the minimum allowed battery voltage. In order to guaranty circuits functionality, it is desirable to have DC-DC converters able to provide regulated supplies at voltages below the battery voltage when the battery is fully charged (buck mode) and to provide regulated supplies above the battery voltage when it is close to its minimum charge level (boost mode).

Furthermore it is desirable that such converters be able to pass from buck mode to boost mode automatically, without requiring intervention from the person using the equipment. Because the electronics receiving the regulated supply is sensitive, severe constraints are place on the level of disturbances on the supply such as ripple or spikes that can be tolerated.

An implementation of a DC-DC converter uses a measurement of the voltage at the output of the DC-DC converter to set an error voltage at a comparator. This error signal is compared to a voltage ramp in order to produce a pulse width modulated (PWM) stream. The PWM stream is then used to control a switching system connected to a rectifier which contains an inductor. The DC-DC converter has a single control loop based on the output voltage.

To avoid instability that could occur in such an implementation of the DC-DC converter under certain load conditions, a trade-off between bandwidth, maximum load, efficiency and responsiveness to transients must be made. It is desirable to obtain the best possible maximum load and responsiveness to transients whilst avoiding instability.

### SUMMARY OF THE INVENTION

For the above reasons, it is desirable to make a DC-DC converter able to pass smoothly between buck and boost modes without the problems of instability and without significant increase chip area or power consumption.

More generally, it is desirable to improve the stability of a boost converter. According to an aspect, there is provided a switch-mode voltage regulator, able to provide a regulated output power supply both below and above level of the unregulated input power supply, which comprises:

an inductor;

a generator for producing a voltage ramp;

circuitry for producing at least two pulse streams from said voltage ramp;

switch control circuitry for controlling switching of a current in the inductor according to said pulse streams; and which further comprises a first control loop adapted to modulate the form of the voltage ramp according to the current flowing in the inductor.

According to an embodiment, the switch-mode voltage regulator further comprises a current-to-voltage modulator coupled to said inductor and to said voltage ramp generator.

According to an embodiment, said switch control circuitry is further controlled by a second control loop according to a voltage present on an output of the regulator.

According to an embodiment, said second control loop comprises:

a reference voltage source;

an amplifier having a first input coupled to said reference voltage source and a second input coupled to said output;

a threshold generator; and

a comparator.

According to an embodiment, said comparator has a first input coupled to said threshold generator and a second input coupled to said current-to-voltage modulator.

According to an embodiment, the switch mode voltage regulator has an output stage further comprising:

a first switch coupled between an unregulated supply terminal and a first terminal of the inductor;

a second switch coupled between the first terminal of the inductor and a negative supply;

a third switch coupled between a second terminal of the inductor and the regulated supply output;

a fourth switch coupled between the second terminal of the inductor and the negative supply; and

a capacitor coupled between the regulated supply output and the negative supply.

According to an embodiment, the first and third switches are PMOS transistors and the second and fourth switches are NMOS transistors.

According to an embodiment, there is provided a battery-powered mobile equipment comprising a switch-mode voltage regulator.

There is also provided a method of controlling an output voltage of a switch-mode voltage regulator having an inductor comprising the steps of:

generating at least one pulse modulated signal from a voltage ramp to switch a current in the inductor; and

modulating said voltage ramp according to the current flowing in the inductor.

According to an embodiment, a comparison is made of said voltage ramp after modulation to at least one threshold derived from a measurement of said output voltage.

According to an embodiment, said comparison is used to modulate the width of pulses in at least one pulse stream.

According to an embodiment, said pulse stream is used to control the switching of a current flowing in the inductor.

According to an embodiment, two pulse streams are used to control the switching of a current flowing in the inductor.

According to an embodiment, charge storage is used to derive a DC voltage from the current flowing in the inductor.

According to an embodiment, said voltage ramp has a constant time period.

### BRIEF DESCRIPTION OF THE DRAWINGS

FIG. 1 represents an embodiment of a buck-boost converter;

FIG. 2 represents the output stage of the buck-boost converter of FIG. 1 in more detail;

FIGS. 3A, 3B and 3C represent three phases of operation of the output stage of the buck-boost converter of FIGS. 1 and 2;

FIG. 4 is a timing diagram illustrating the operation of a usual DC-DC converter.

FIG. 5 is a timing diagram illustrating the operation of the converter of FIG. 1.

FIG. 6 is a timing diagram illustrating the operation of the DC-DC of FIG. 1 in boost mode.

FIG. 7 is a block diagram a mobile battery powered equipment containing a buck-boost converter according to an embodiment of the invention.

### DETAILED DESCRIPTION OF THE INVENTION

Same references designate same elements in the different figures. Furthermore, only the elements which are useful to understanding are represented and disclosed. Especially the circuits downstream of the DC-DC converter are not detailed, these circuits being compatible with any usual use of a regulated voltage.

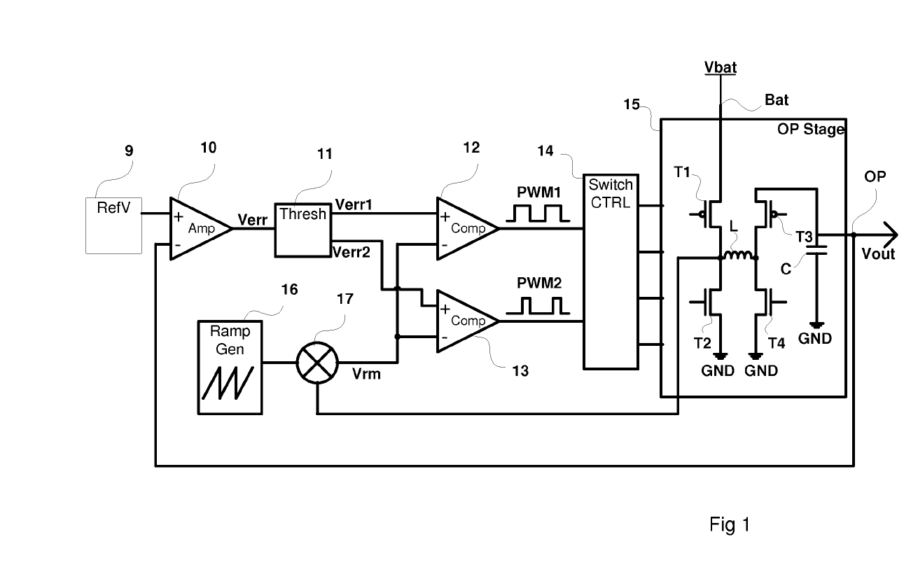

FIG. 1 represents an embodiment of a buck-boost converter, able to pass between buck and boost modes without interruption of the regulated supply.

An error amplifier 10 (Amp) receives a reference voltage from a reference voltage source 9 (RefV) at its non-inverting input. Error amplifier 10 has its inverting input coupled to output OP of the buck-boost converter. The error signal Verr output by error amplifier 10 is provided to a threshold generator 11 (Thresh) which supplies a first derived error signal Verr1 to a first comparator 12 (Comp) and a second derived error signal Verr2, offset from derived error signal Verr1, to a second comparator 13. Derived error signal Verr1 may be the same as or different to error signal Verr.

Comparators 12 and 13 provide pulse streams, PWM1 and PWM2 respectively, to switch control logic 14 (Switch CTRL). Switch control logic 14 supplies four signals to an output stage 15 (OP Stage). Pulse streams PWM1 and PWM2 are pulse width modulated in this example.

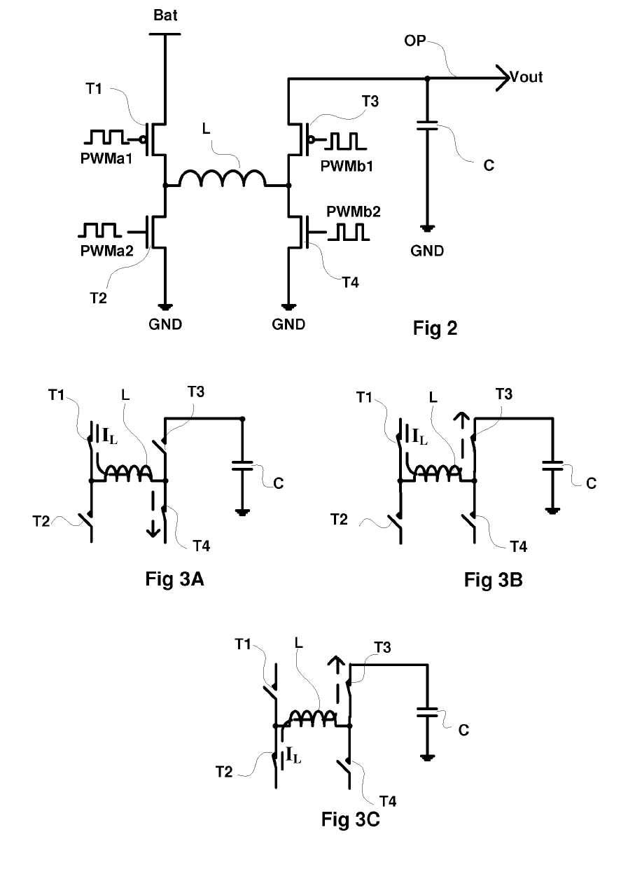

FIG. 2 represents the output stage 15 in more detail. A first PMOS transistor T1 is coupled between a supply terminal Bat which receives a supply Vbat coming from the battery (not shown), and a first terminal of an inductor L. Between the first terminal of inductor L and a ground GND is coupled a first NMOS transistor T2. Between an output OP, providing the regulated voltage, and a second terminal of inductor L, is coupled a second PMOS transistor T3. A second NMOS transistor T4 is coupled between the second terminal of inductor L and ground GND. A capacitor C is coupled between output OP and ground GND.

More generally, transistors T1-4 can be any type of switch. Switches, T1-4, are opened and closed by two PWM streams, PWMa, PWMb, delivered by the switch control logic 14. Pulse streams PWMa1 and PWMa2 are two PWM signals derived from PWM stream PWMa and are respectively used to control switches T1 and T2. Pulse streams PWMb1 and PWMb2 are two PWM signals derived from PWM stream PWMb and are respectively used to control transistors T3 and T4. The four PWM streams share the same constant time period and are derived from a combination of PWM streams PWMa and PWMb performed by switch control logic 14.

FIGS. 3A, 3B and 3C represent three operating configurations of the output stage 15. In the interests of clarity, switches T1-T4 and inductor L are focused on and other elements are not shown.

FIG. 3A shows a first configuration (phase 1) where switches T1 and T4 are closed whilst switches T2 and T3 are open. A current I_{L} flows through inductor L as shown, from supply Vbat to ground GND. Whilst this configuration is maintained, the current I_{L} increases in magnitude at a constant rate.

FIG. 3B shows a second configuration (phase 2) where switches T1 and T3 are closed and switches T2 and T4 are open. A current I_{L} flows through inductor L from supply Vbat to output OP.

FIG. 3C shows a third configuration (phase 3) where switches T1 and T4 are open and switches T2 and T3 are closed. The current I_{L} flows from ground GND to output OP and decreases in magnitude at a constant rate.

When phases 2 and 3 are alternated, the DC-DC converter operates in purely buck mode. In this mode, it is convenient to note that in both phases, energy is transferred from inductor L to capacitor C.

When phases 1 and 2 are alternated, the DC-DC converter operates purely in boost mode. In this mode, it is convenient to consider that during phase 1, energy is being stored in inductor L that will be then delivered to capacitor C during phase 2. It can be seen that during phase 3, capacitor C is receiving charge whereas during phase 1 it is not.

When phases 1 and 3 are alternated, the DC/DC converter operates purely in 2 phase Buck-Boost mode. In this mode, it is convenient to consider that during phase 1, energy is being stored in inductor L that will be delivered to capacitor C during phase 3.

The width of the pulses in pulse streams PWM1 and PWM2 is modulated in proportionality to the difference between Vout and Vref so as to set Vout equal to Vref.

As can be easily understood, to operate the DC-DC converter in either purely buck or purely boost mode, only one PWM stream would be required. The modulation of the PWM stream and the control of the switching could simply be adapted to the mode, buck or boost, being used. However in such a DC-DC converter, there would be unacceptable levels of disturbances, such as spikes or ripple, on the regulated supply during the transitions between buck and boost modes.

A solution to this problem is a DC-DC converter that can function with all three phases at once, transitioning gradually from using one pair of configurations to the other pair of configurations. For this, two PWM streams are required simultaneously.

In one solution for controlling two PWM streams, a single ramp signal is used. From voltage Verr, two error signals at different levels are derived. The single ramp signal is compared to these two error signals.

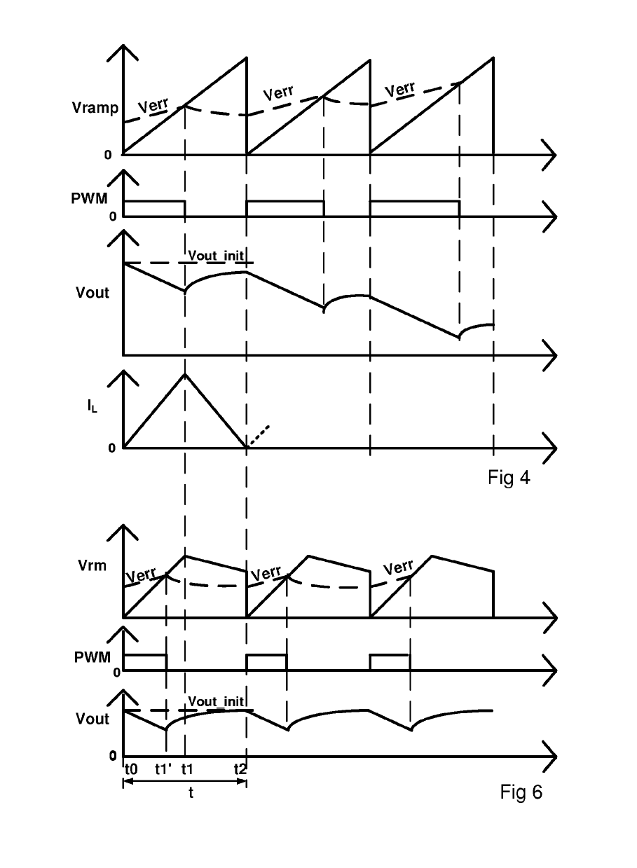

FIG. 4 represents the change over time of voltages and currents in a usual DC-DC converter in boost mode when a sudden large increase in demand from the load for current beyond normal operating parameters has occurred. At time t0 a cycle starts in phase 1 and voltage ramp Vramp begins.

The current I_{L} in inductor L rises at a constant rate as shown by the graph of I_{L}.

Because the battery is not connected to the output during this phase, all the current demanded by the load is supplied by capacitor C which results in capacitor C being discharged. Consequently, output voltage Vout drops from its initial value Vout_init. The single control loop, which measures Vout, increases the error signal voltage as shown by the dotted line Verr superimposed on the graph of Vramp. In this illustration, no account is taken any propagation delays between changes of output voltage Vout and adjustments to Verr.

At time t1, voltage Vramp crosses threshold voltage Vth and the pulse of pulse stream PWM is ended. The DC-DC converter passes into phase 3 and current I_{L} decreases as shown by the graph of I_{L}. Charging of capacitor C starts and voltage Vout rises accordingly. At time t2 the cycle is ended and another one begins.

However, during the phase 3, voltage Vout has not returned to its initial level Vout_init so error signal Verr starts at a higher level than it did in the previous cycle and rises to higher levels than before. Consequently, the duration of phase 1 in this cycle is longer than that of the previous cycle and the duration of phase 3 is shorter. Capacitor C is therefore discharged to an even greater degree and voltage Vout is even lower at the end of this cycle than when this cycle was started. If the demand for current remains unchanged, in the succeeding cycle, the events are repeated in a similar manner and the downward trend of the average of voltage Vout continues. This trend will stop if circumstances change so that the energy stored in coil is high enough to increase output voltage during the time coil is connected to output.

It is possible to avoid this situation by limiting the maximum allowable duty cycle and so limiting the performance of DC-DC converter in terms of maximum allowed current and reducing the bandwidth. A more common occurrence is where the increase in demand for current is transient. In this case voltage Vout drops as before and then overshoots when it rises again, causing unacceptable levels of ripple on the regulated output. Limiting the bandwidth of the DC-DC converter has the effect of deteriorating its ability to cope with transient demands.

The control loop is unable to take into account the energy actually being stored in the inductor L sufficiently quickly.

However, it is preferable to find a solution which does not involve reducing the loop bandwidth in order to obtain a system that is best able to control level of spikes and ripple produced in response the load variations.

Another solution to the instability condition in boost converters is to use the difference voltage Verr to define the slope of a negative going voltage ramp of constant time period. This voltage ramp is compared continuously to a signal of voltage proportional to the current I_{L} flowing in the inductor in order to set the width of the pulses in the pulse stream. In order to use this solution with a buck-boost converter having three phases, it would be necessary to duplicate the ramp generation circuitry, which would imply an increase in chip area and power consumption.

According to the embodiment of FIG. 1, a voltage ramp generator 16 (Ramp Gen) provides a voltage ramp to a first input of modulator circuit 17. The common point of switches T1, T2 and inductor L is coupled to a second input of modulator 17. Modulator 17 is able to modulate a signal representative of the current present in inductor L onto the signal coming from voltage ramp generator 16. Modulator 17 supplies a modulated ramp signal to the inverting inputs of comparators 12 and 13.

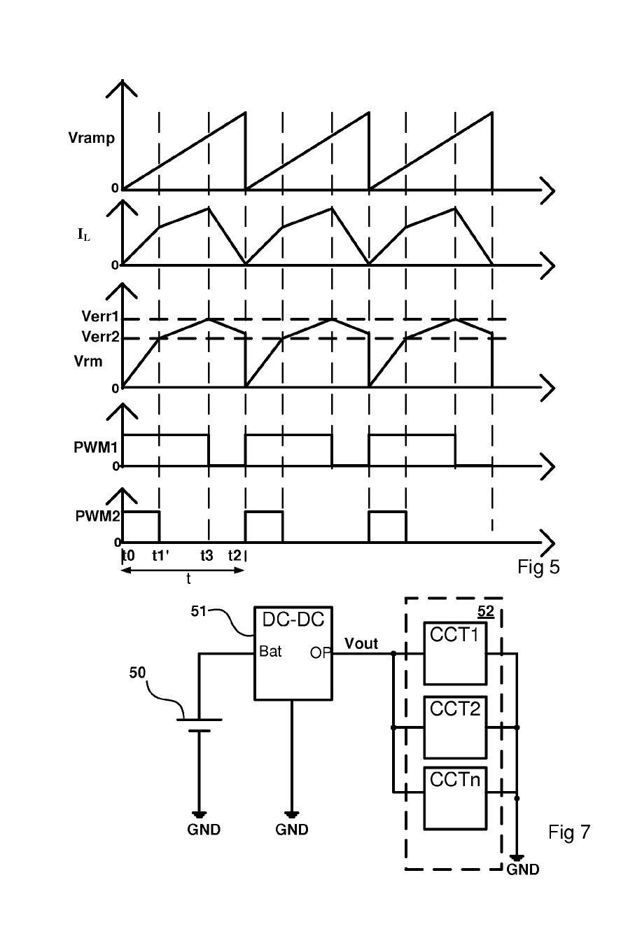

FIG. 5 is a timing diagram illustrating the operation of the buck-boost converter as described in FIG. 2.

A voltage ramp Vramp of constant time period t is produced by ramp generator 16. Signal I_{L} represents the current I_{L} flowing in inductor L. Voltage ramp Vramp is modulated by modulator 17 in proportion to current I_{L}, producing a signal Vrm.

The control loop which measures output voltage Vout sets the error signals Verr1 and Verr2 to the levels shown.

At time t0 a time period has just been started in phase 1 (as in FIG. 3A) and a pulse is started in both pulse streams PWM1 and PWM2.

Between t0 and t1′, the slope of Vrm is increased relative to Vramp to reflect the increasing value of current I_{L}. At time t1′, Vrm crosses error signal Verr2 and the pulse in pulse stream PWM2 is ended. At this point the buck-boost converter passes into phase 2. During this phase, the current flowing I_{L} is still increasing but less rapidly than in phase 1 and this is reflected in the reduced slope of voltage ramp Vrm.

At time t3 voltage ramp Vrm crosses error signal Verr1 and the pulse in pulse stream PWM1 is ended. At this point the buck-boost converter enters phase 3. During this phase, the current I_{L} is decreasing and consequently, the slope of Vrm is negative.

Any variations of error signals Verr1, Verr2 occurring within a cycle are not shown at this point for simplicity.

Finally at t2 the cycle is complete and a new one begins.

FIG. 6 represents in more detail the operation of the DC-DC converter of FIG. 1 in boost mode that has undergone a large increase in demand for current from the load.

The graph of Vrm represents, as in FIG. 5, the voltage of the modulated voltage ramp. As in FIG. 4, a cycle starts in phase 1 at time t0. As in FIG. 4, the current in inductor L, I_{L}, increases at a constant rate as shown. Because capacitor C must alone supply the current required by the load, it is discharged and voltage Vout drops as shown. As in FIG. 4, error signal Verr increases. For simplicity, only one error signal, Verr, is shown.

At time t1′, voltage ramp Vrm crosses error signal Verr and phase 3 begins. The phase 2 of FIG. 5 is not represented. In phase 3, current I_{L} reduces as before, capacitor C is charged again and voltage Vout rises.

Time t1′ is earlier than time t1. This is because the slope of Vrm during phase 1 has been increased in relation to the level of current I_{L}, and voltage ramp Vrm crosses error signal Verr earlier than would have the un-modulated voltage ramp Vramp of FIG. 4.

Therefore phase 1 is kept shorter and phase 3 is kept longer than would have been the case without the control loop modulating the voltage ramp.

The result of this is that the discharging of capacitor C during phase 1 is lessened and phase 3 is long enough for it to be charged back up to the level it was at the start of the cycle. Thus Vout rises back to its initial level and the error signal Verr starts at the level at which it started in the previous cycle.

The subsequent cycles occur in a similar manner and voltage Vout does not display a downward trend longer than one cycle.

Because it has not been necessary to reduce the control loop bandwidth, the DC-DC converter is better able to respond to transient changes in demand. Furthermore this has been achieved with only a small increase in chip area and power consumption.

The conversion gain of the second control loop, including the modulator and the setting of the second error signal Verr2 must be adjusted in accordance with the parameters of the DC-DC converter in question. Such parameters include the voltages of the battery and the regulated output, the output current, the inductor and capacitor values and bandwidth desired for the output voltage control loop.

FIG. 7 represents a mobile battery powered system where a battery 50, rechargeable or not is coupled between a ground GND and a positive input Bat of a DC-DC converter 51. An output OP makes available a regulated supply Vout and is coupled to positive supplies of a plurality of circuits 52 (CCT1, CCT2 . . . CCTn). The plurality of circuits 52 have their negative supplies coupled to ground GND.

Switch control logic 14 has not been described in detail and one of ordinary skill will be able implement such circuitry.

One of ordinary skill will be able to implement the circuitry for producing reference voltage Vref.

The foregoing, with its features, aspects and purposes is given by way of illustration and not limitation. Indeed, it is not intended that the embodiment described be considered the only one concerned by the present invention, nor should it be considered limited to DC-DC converters having an output stage like that described.

Indeed any switch-mode DC-DC converter having a boost mode where one part of the cycle sees the capacitor not connected to the battery may be at risk of instability.

Therefore, a feedback loop which modulates the voltage ramp in accordance with the current in the inductor could be used for other types of converter having a different configuration of output stage, for example those using diodes in the place of some of the switches.

The above examples have been discussed in terms of pulse width modulation. However more complex modulations, such as those using pulse-skipping, could also be used.

Furthermore, even though a DC-DC converter with two pulse streams has been discussed, DC-DC converters having more than two pulse streams and having a control loop modulating a voltage ramp according to the current in the inductor would also be possible. An example of such a converter would be one where a central control and pulse stream generator is used to control multiple output stages. In this case, a circuit for multiplexing the measurements of the currents in the inductors would be necessary.

1. A switch-mode voltage regulator, able to provide a regulated output power supply both below and above level of the unregulated input power supply, comprising:
an inductor (L);
a generator for producing a voltage ramp; and
circuitry for producing at least two pulse streams from said voltage ramp; switch control circuitry for controlling switching of a current in the inductor according to said pulse streams;
wherein it further comprises a first control loop adapted to modulate the form of the voltage ramp according to the current flowing in the inductor.

2. A switch-mode voltage regulator according to claim 1 further comprising a current-to-voltage modulator coupled to said inductor and to said voltage ramp generator.

3. A switch-mode voltage regulator according to claim 1 wherein said switch control circuitry is further controlled by a second control loop according to a voltage present on an output (OP) of the regulator.

4. A switch-mode voltage regulator according to claim 3 wherein said second control loop comprises:
a reference voltage source;
an amplifier having a first input coupled to said reference voltage source and a second input coupled to said output;
a threshold generator; and
a comparator.

5. A switch-mode voltage regulator according claim 4 wherein said comparator has a first input coupled to said threshold generator and a second input coupled to said current-to-voltage modulator.

6. A switch-mode voltage regulator according to claim 1 having an output stage further comprising:
a first switch (T1) coupled between an unregulated supply terminal (Bat) and a first terminal of the inductor (L);
a second switch (T2) coupled between the first terminal of the inductor and a negative supply (GND);
a third switch (T3) coupled between a second terminal of the inductor and the regulated supply output (OP);
a fourth switch coupled between the second terminal of the inductor and the negative supply; and
a capacitor (C) coupled between the regulated supply output and the negative supply.

7. A switch-mode voltage regulator according to claim 6 wherein the first and third switches (T1, T3) are PMOS transistors and the second and fourth switches (T2, T4) are NMOS transistors.

8. A battery-powered mobile equipment comprising a switch-mode voltage regulator according to claim 1.

9. A method of controlling an output voltage of a switch-mode voltage regulator having an inductor comprising the steps of:
generating at least one pulse modulated signal (PWM1, PWM2) from a voltage ramp (Vrm) to switch a current (I_{L}) in the inductor (L); and
modulating said voltage ramp according to the current flowing in the inductor.

10. A method according to claim 9 wherein a comparison is made of said voltage ramp (Vrm) after modulation to at least one threshold (Vth1, Vth2) derived from a measurement of said output voltage (Vout).

11. A method according to claim 10 wherein said comparison is used to modulate the width of pulses in at least one pulse stream (PWM1, PWM2).

12. A method according to claim 11 wherein said pulse stream (PWM1, PWM2) is used to control the switching of a current flowing (I_{L}) in the inductor (L).

13. A method according to claim 12 wherein two pulse streams (PWM1, PWM2) are used to control the switching of a current flowing (I_{L}) in the inductor (L).

14. A method according to claim 12 wherein charge storage is used to derive a DC voltage (Vout) from the current flowing in the inductor (L).

15. A method according to claim 9 wherein said voltage ramp has a constant time period (t).
